(19) United States
(12) Patent Application Publication
(10) Pub. No.: US 2006/0115689 A1
(43) Pub. Date: Jun. 1, 2006

(54) Electronic device and battery replacing method thereof

(75) Inventor: Yu-Chen Lee, Chiayi City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/287,900

(22) Filed: Nov. 28, 2005

(30) Foreign Application Priority Data
Nov. 29, 2004 (TW) 93136799

(51) Int. Cl. H01M 2/10; H01M 10/44

(52) U.S. Cl. 429/9; 429/99; 429/50

(57) ABSTRACT

An electronic device capable of replacing a first battery with a second battery in a power-on condition is provided. The first battery and the second battery respectively have a first conducting sheet and a second conducting sheet. The electronic device includes a circuit board and a battery tray. The battery tray used for placing the first battery has a battery conducting sheet for contacting the first conducting sheet and transmitting the power of the first battery to the circuit board. The battery replacing method includes the steps of placing the second battery into the battery tray such that the second conducting sheet contacts the battery conducting sheet before the first conducting sheet is departed from the battery conducting sheet, and departing the first battery from the battery tray and placing the second battery into the battery tray completely.

This application claims the benefit of Taiwan application Serial No. 93136799, filed Nov. 29, 2004, the subject matter of which is incorporated herein by reference.

### BACKGROUND OF THE INVENTION

1. Field of the Invention

The invention relates in general to an electronic device and battery replacing method thereof, and more particularly to an electronic device capable of replacing a battery in a power-on condition and battery replacing method thereof.

2. Description of the Related Art

Referring to FIG. 1, a structural diagram showing how a battery is replaced in a conventional mobile phone is shown. Mobile phone 100 includes a circuit board 110 and a battery tray 120. The battery tray 120 is used for placing a battery 130. The battery tray 120 includes a conducting elastic sheet 122. The battery 130 includes a conducting sheet 132. When the battery 130 is placed into the battery tray 120, the conducting elastic sheet 122 contacts the conducting sheet 132 and supplies the power of the battery 132 to the circuit board 110.

Normally, when the battery 130 is flat, the mobile phone 100 has to be switched off before the battery 130 is unloaded from the battery tray 120, and then a back-up battery 140 is used to replace the battery 130. After the battery has been replaced, the mobile phone 100 may be switched on again. Meanwhile, the battery 140 also has a conducting sheet 142 capable of contacting the conducting elastic sheet 122 and supplying power to the circuit board 110.

However, such battery replacing method requires additional operating time for switching the mobile phone on/off. If the battery runs flat in the course of conversation by mobile phone, the user has to terminate the conversation in order to replace the battery no matter the user holds the mobile phone or uses earphones. This is indeed very inconvenient to the user of the mobile phone.

### SUMMARY OF THE INVENTION

It is therefore the object of the invention to provide an electronic device and battery replacing method thereof. With the special design of a battery conducting sheet disposed on a battery tray of the electronic device and the design of a conducting sheet of the battery, the conducting sheet of another battery can contact the battery conducting sheet before the conducting sheet of the battery is departed from the battery conducting sheet. Therefore, the electronic device is capable of replacing a battery in a power-on condition, saving the repeats in switching on/off the electronic device.

According to an object of the invention, an electronic capable of replacing a first battery with a second battery in a power-on condition is provided. The first battery and the second battery respectively have a first conducting sheet and a second conducting sheet. The electronic device includes a circuit board and a battery tray. The battery tray used for placing the first battery includes a battery conducting sheet used for contacting the first conducting sheet and transmitting the power of the first battery to the circuit board. When the second battery is used to replace the first battery, the second conducting sheet and the first conducting sheet contact the battery conducting sheet at the same time before the first conducting sheet is departed from the battery conducting sheet.

According to an object of the invention, another electronic device capable of replacing a first battery with a second battery in a power-on condition is provided. The first battery and the second battery respectively have a first conducting sheet and a second conducting sheet. The electronic device includes a circuit board and a battery tray. The battery tray used for placing the first battery includes a first battery conducting sheet and a second battery conducting sheet. The first battery conducting sheet is used for contacting the first conducting sheet and transmitting the power of the first battery to the circuit board. The second battery conducting sheet is electrically connected to the circuit board. When the second battery is used to replace the first battery, the second conducting sheet of the second battery contacts the second battery conducting sheet and transmits the power of the second battery to the circuit board before the first conducting sheet is departed from the first battery conducting sheet.

According to another object of the invention, a method capable of replacing a battery in a power-on condition is provided. The method includes the steps of placing the second battery into the battery tray, such that the second conducting sheet contacts the battery conducting sheet before the first conducting sheet is departed from the battery conducting sheet, and departing the first battery from the battery tray and placing the second battery into the battery tray completely.

According to yet another object of the invention, another method capable of replacing battery in a power-on condition is provided. The method includes placing the second battery into the battery tray such that the second conducting sheet contacts the second battery conducting sheet before the first conducting sheet is departed from the first battery conducting sheet, and departing the first battery from the battery tray and placing the second battery into the battery tray completely.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a structural diagram showing how a battery is replaced in a conventional mobile phone;

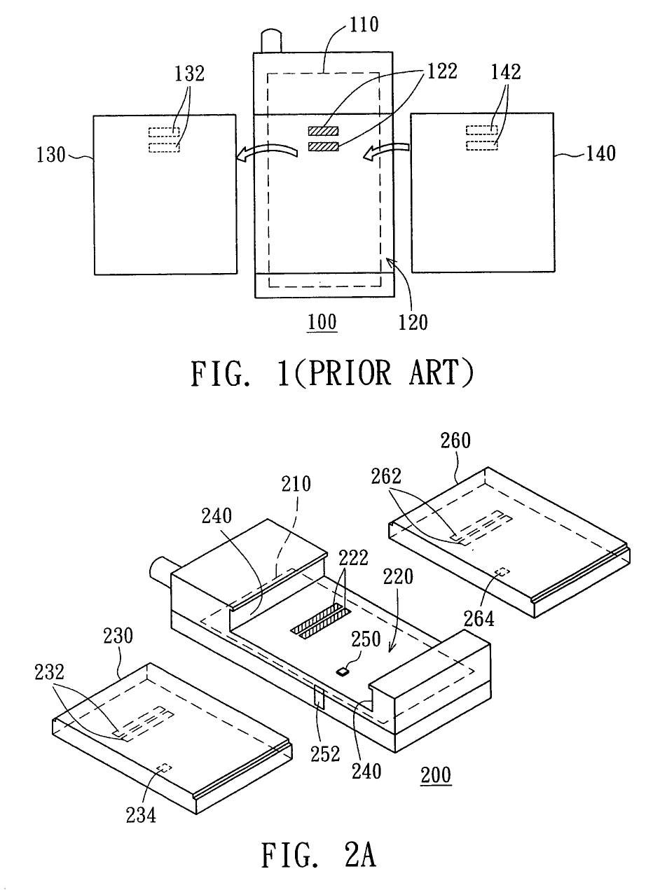

FIG. 2A is an exploded diagram of a mobile phone according to a first embodiment of the invention;

FIG. 2B is a method flowchart of replacing the mobile phone battery in a power-on condition of the mobile phone according to the first embodiment of the invention;

FIG. 2C to FIG. 2F are operating processes showing how the battery of the mobile phone is replaced according to the first embodiment of the invention;

FIG. 3A is an exploded diagram of a mobile phone according to a second embodiment of the invention;

FIG. 3B is a diagram showing the contact between the battery conducting sheet of the battery tray and the conducting sheet of the battery before the battery is placed into the mobile phone according to the second embodiment of the invention;

FIG. 3C is a method flowchart of replacing the mobile phone battery in a power-on condition according to the second embodiment of the invention; and

FIG. 3D to FIG. 3G are operating processes showing how the battery of the mobile phone is replaced according to the second embodiment of the invention.

### DETAILED DESCRIPTION OF THE INVENTION

How a battery of the electronic device according to the invention is replaced in a power-on condition is exemplified by a mobile phone and is disclosed in two embodiments elaborated below.

### EMBODIMENT ONE

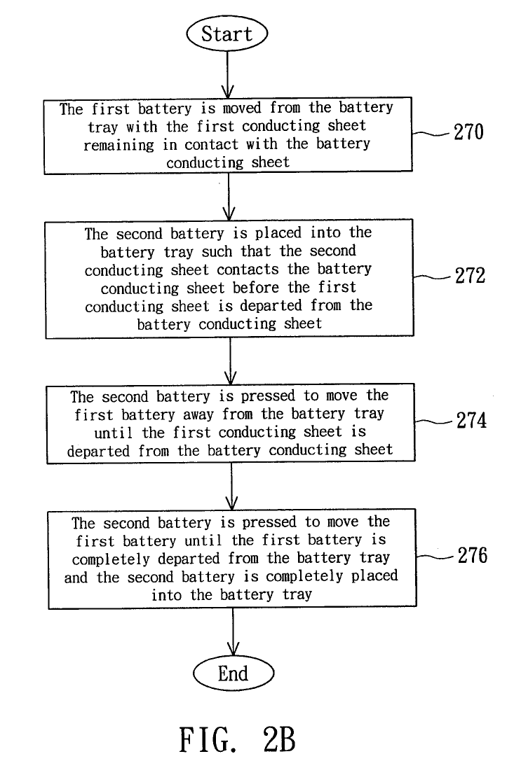

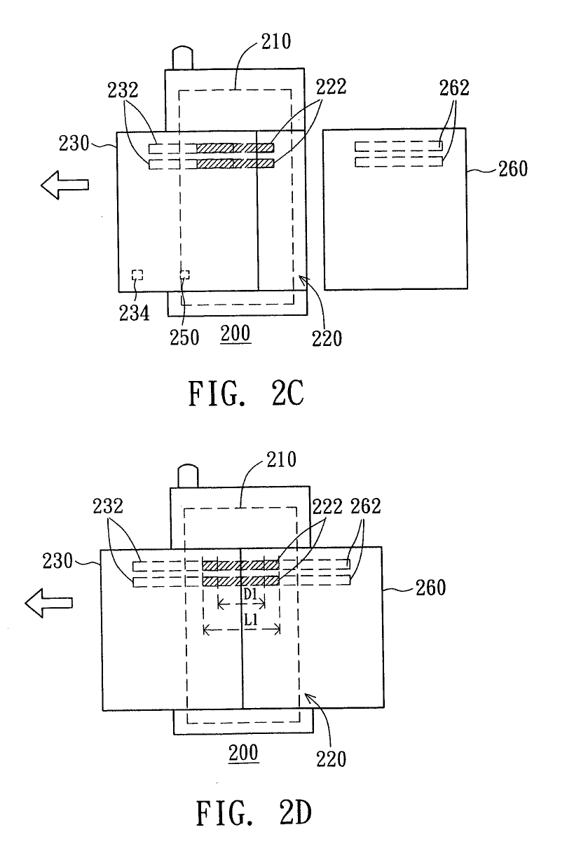

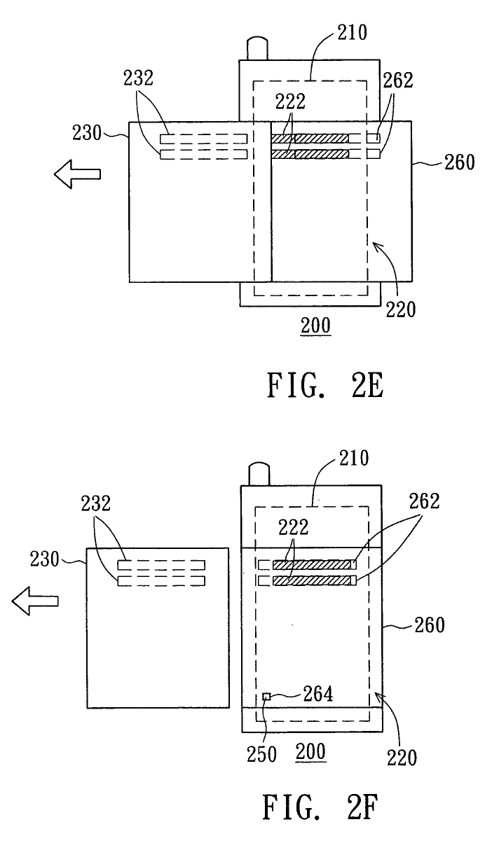

Referring to FIG. 2A, an exploded diagram of a mobile phone according to a first embodiment of the invention is shown. Mobile phone 200 includes a circuit board 210, a battery tray 220 and a first battery 230. The battery tray 220 is used for replacing the first battery 230, and the first battery 230 is used for providing the circuit board 210 with necessary power. The battery tray 220 further includes a set of battery conducting sheets 222, and the first battery 230 further includes a set of first conducting sheets 232. When the first battery 230 is placed into the battery tray 220, the two battery conducting sheets 222 respectively contact the two first conducting sheets 222 and transmit the power of the first battery 230 to the circuit board 210.

Each of the top and bottom of the battery tray 220 has a slide channel 240 via which the first battery 230 slides to be placed into or departed from the battery tray 220. Besides, the battery tray 220 has a locking shaft 250 disposed therein, and one lateral side of the mobile phone 200 has a locking shaft control button 252 disposed thereon for controlling the locking shaft 250 to move upward or downward. When the first battery 230 is placed into the battery tray 220, the locking shaft 250 is wedged with the first fixing tray 234 of the first battery 230 to fix the first battery 230. When the first battery 230 is to be departed from the battery tray 220, the locking shaft control button 252 brings the locking shaft 250 to move downward, such that the first battery 230 is departed from the battery tray 220.

Besides as shown in FIG. 2A, the mobile phone 200 further has a second battery 260 used for replacing the first battery 230. The second battery 260 includes a set of second conducting sheets 262 and a second fixing tray. The second battery 260 slides to be placed into or departed from the battery tray 220 via the slide channels 240 of the mobile phone 200. When the second battery 260 is placed into the battery tray 220, the locking shaft 250 is wedged with the second fixing tray 264 of the second battery 260 to fix the second battery 260, while the second conducting sheet 262 contacts the battery conducting sheet 222 and transmits the power of the second battery 260 to the circuit board 210.

Referring to FIG. 2B, a method flowchart of replacing a first battery 230 with a second battery 260 in a power-on condition of the mobile phone 200 is shown. At first, the method begins at step 270, the first battery 230 is moved from the battery tray 220 with the first conducting sheet 232 remaining in contact with the battery conducting sheet 222. As shown in FIG. 2C, the locking shaft 250 is lowered down to be departed from the first fixing tray 234, and the first battery 230 is pushed to slide along the arrow direction with the first conducting sheet 232 remaining connected to the battery conducting sheet 222. Therefore, the mobile phone 200 is still able to provide power to the circuit board 210 by the first battery 230. Next, proceed to step 272, the second battery 260 is placed into the battery tray 220, such that the second conducting sheet 262 contacts the battery conducting sheet 222 before the first conducting sheet 232 is departed from the battery conducting sheet 222. As shown in FIG. 2D, the second battery 260 is placed into the battery tray 220 to press and move the first battery 230 along the arrow direction until the first conducting sheet 232 and second conducting sheet 262 contact the battery conducting sheet 222 at the same time. Meanwhile, the mobile phone 200 can provide power to the circuit board 210 by the first battery 230 and the second battery 260 at the same time.

It is noteworthy that to assure the first conducting sheet 232 of the first battery 230 and the second conducting sheet 262 of the second battery 260 to be contacted at the same time so that the power of the mobile phone 200 will not be disconnected during the battery replacing process, the length L1 of the battery conducting sheet 222 has to be larger than the shortest distance D1 between the first conducting sheet 232 of the first battery 230 and the second conducting sheet 262 of the second battery 260 as the two batteries connect together.

Continue to proceed to step 274, the second battery 260 is pressed along the arrow direction to move the first battery 230 away from the battery tray 220 until the first conducting sheet 232 is departed from the battery conducting sheet 222. The contact area between the second conducting sheet 262 and the battery conducting sheet 222 would become larger as shown in FIG. 2E. Meanwhile, the mobile phone 200 provides power to the circuit board 210 by the second battery 260. At last, proceed to step 276, the second battery 260 is pressed to move the first battery 230 along the arrow direction until the first battery 230 is completely departed from the battery tray 220 and the second battery 260 is completely placed into the battery tray 220, the locking shaft 250 is wedged with the second fixing tray 264, and the replacement of battery is completed here as shown in FIG. 2F. Meanwhile, the mobile phone 200 continues to provide power to the circuit board 210 by the second battery 260. Therefore, the mobile phone 200 of the invention is capable of replacing a battery in a power-on condition, saving the repeats in switching on/off the electronic device.

### EMBODIMENT TWO

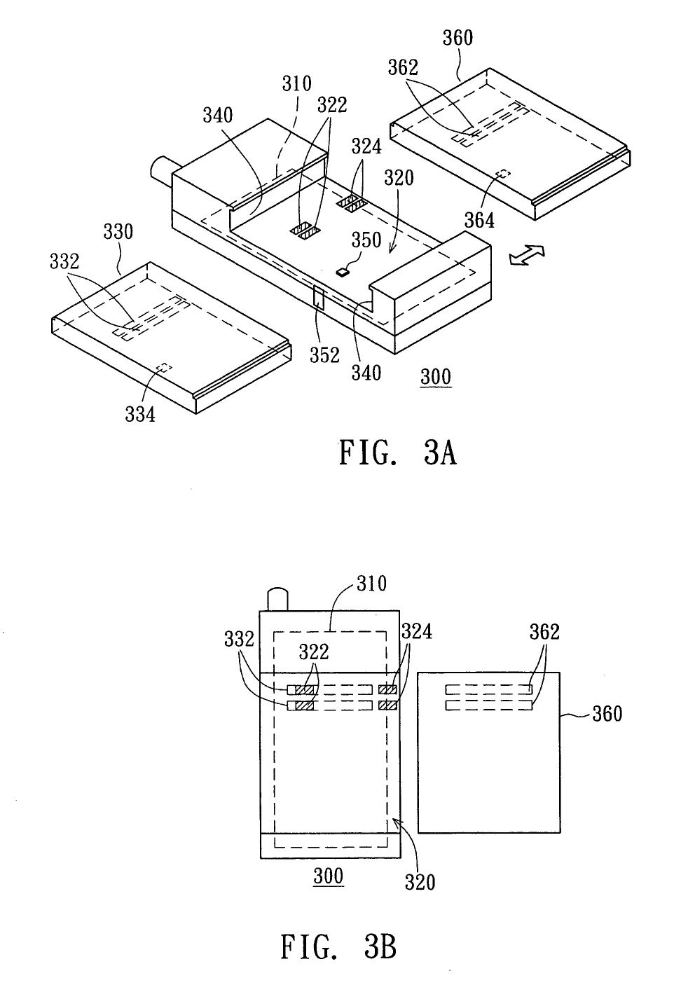

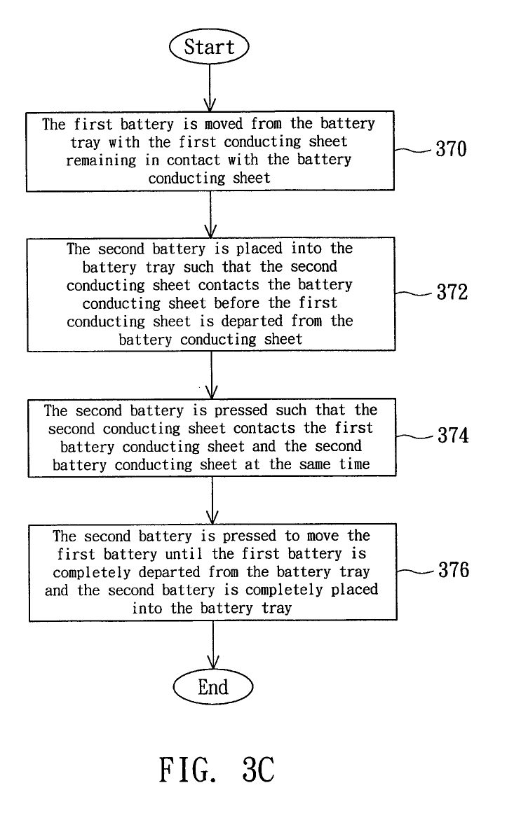

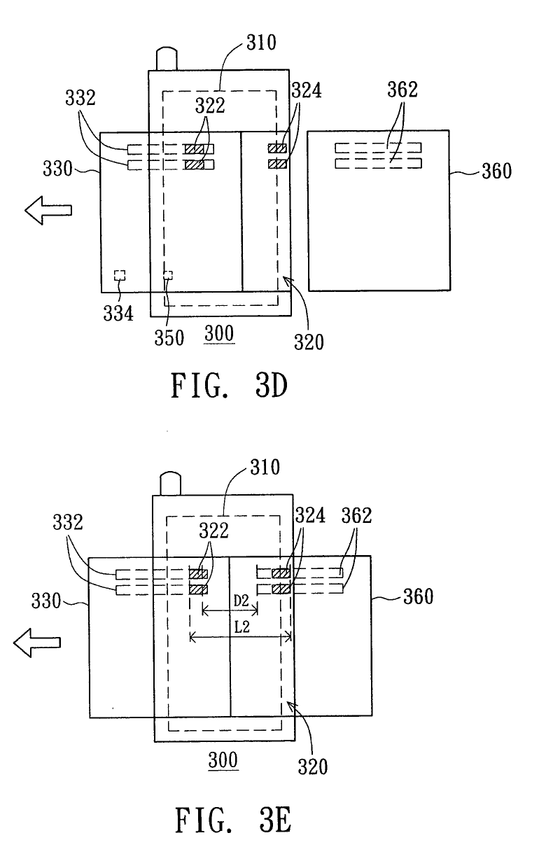

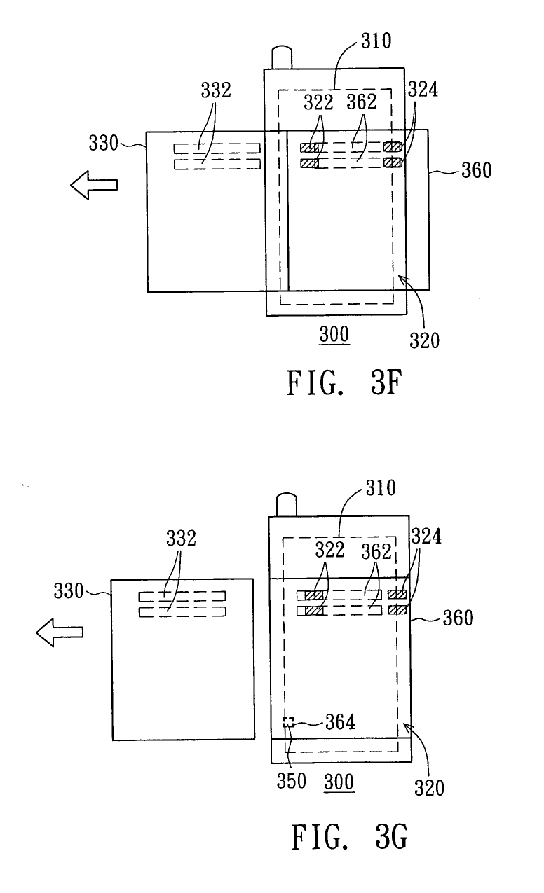

Referring to FIG. 3A, an exploded diagram of a mobile phone according to a second embodiment of the invention is shown. Mobile phone 300 includes a circuit board 310, a battery tray 320 and a first battery 330. The battery tray 320 is used for placing the first battery 330, which is used for providing the circuit board 310 with necessary power. The battery tray 320 further includes a first battery conducting sheet 322 and a second battery conducting sheet 324. The first battery conducting sheet 322 and the second battery conducting sheet 324 are positioned in the same straight line with the sliding direction (double arrow direction in the diagram) of the first battery 330. The first battery 330 includes a first conducting sheet 332. When the first battery 330 is placed into the battery tray 320, the first battery conducting sheet 322 contacts the first conducting sheet 332 and transmits the power of the first battery 330 to the circuit board 310. The second battery conducting sheet 324 is electrically connected to the circuit board 310.

Each of the top and bottom of the battery tray 320 has a slide channel 340 via which the first battery 330 slides to be placed into or departed from the battery tray 320. Besides, the battery tray 320 has a locking shaft 350 disposed therein, and one lateral side of the mobile phone 300 has a locking shaft control button 352 disposed thereon for controlling the locking shaft 350 to move upward or downward. When the first battery 330 is placed into the battery tray 320, the locking shaft 350 is wedged with the first fixing tray 334 of the first battery 330 to fix the first battery 330. When the first battery 330 is to be departed from the battery tray 320, the locking shaft control button 352 brings the locking shaft 350 to move downward, such that the first battery 330 is departed from the battery tray 320.

Besides as shown in FIG. 3A, the mobile phone 300 further has a second battery 360 used for replacing the first battery 330. The second battery 360 includes a set of second conducting sheets 362 and a second fixing tray 364. The second battery 360 slides to be placed into or departed from the battery tray 320 via the slide channels 340 of the mobile phone 300. When the second battery 360 is placed into the battery tray 320, the locking shaft 350 is wedged with the second fixing tray 364 of the second battery 360 to fix the second battery 360, while the second conducting sheet 362 contacts the battery conducting sheet 322 and transmits the power of the second battery 360 to the circuit board 310. Before the second battery 360 is used to replace the first battery 330, the first conducting sheet 332 of the first battery 330 contacts the first battery conducting sheet 322 to provide the circuit board 310 with necessary power as shown in FIG. 3B.

Referring to FIG. 3C, a method flowchart of replacing a first battery 330 with a second battery 360 in a power-on condition of the mobile phone 300 is shown. At first, the method begins at step 370, the first battery 330 is moved from the battery tray 320 with the first conducting sheet 332 remaining in contact with the battery conducting sheet 322. As shown in FIG. 3D, the locking shaft 350 is brought downward to be departed from the first fixing tray 334, and the first battery 330 is pushed to slide along the arrow direction until the second battery conducting sheet 324 is exposed with the first conducting sheet 332 remaining connected to the battery conducting sheet 322. Therefore, the mobile phone 300 is still able to provide power to the circuit board 310 by the first battery 330.

Next, proceed to step 372, the second battery 360 is placed into the battery tray 320, such that the second conducting sheet 362 contacts the second battery conducting sheet 324 before the first conducting sheet 332 is departed from the first battery conducting sheet 322. As shown in FIG. 3E, the second battery 360 is placed into the battery tray 320 to press and move the first battery 330 along the arrow direction until the first conducting sheet 332 and second conducting sheet 362 respectively contact the first battery conducting sheet 322 and the second battery conducting sheet 324 at the same time. Meanwhile, the mobile phone 300 can provide power to the circuit board 310 by the first battery 330 and the second battery 360.

It is noteworthy that to assure the first conducting sheet 332 of the first battery 330 and the second conducting sheet 362 of the second battery 360 to be contacted at the same time so that the power of the mobile phone 300 will not be disconnected during the battery replacing process, the distance L2 between the two remotest ends of the first battery conducting sheet 322 and the second battery conducting sheet 324 has to be larger than the shortest distance D2 between the first conducting sheet 332 of the first battery and the second conducting sheet 362 of the second battery 360 as the two batteries connect together.

Continue to step 374, the second battery 360 is pressed to move until the second conducting sheet 362 contacts the first battery conducting sheet 322 and the second battery conducting sheet 324 at the same time. As shown in FIG. 3F, the second battery 360 continues to press and move the first battery 330 along the arrow direction until the first conducting sheet 332 is departed from first battery conducting sheet 322, and the second conducting sheet 362 contacts the first battery conducting sheet 322 and the second battery conducting sheet 324 at the same time. Meanwhile, the mobile phone 300 provides the circuit board 310 with necessary power by the second battery 360.

At last, proceed to step 376, the second battery 360 is pressed to move the first battery 330 until the first battery 330 is completely departed from the battery tray 320, and the second battery 360 is completely placed into the battery tray 320, then the locking shaft 350 is wedged with the second fixing tray 364, and the replacement of battery is completed here as shown in FIG. 3G. Meanwhile, the mobile phone 300 continues to provide power to the circuit board 310 through the first battery conducting sheet 322 by the second battery 360. Therefore, the mobile phone 300 of the invention is capable of replacing a battery in a power-on condition, saving the repeats in switching on/off the electronic device.

The invention is exemplified by a battery tray having a set or two sets of bar-like battery conducting sheets with the first battery and the second battery each having a set of bar-like conducting sheets. However, the first battery and the second battery of the mobile phone of the invention respectively having two sets of conducting sheets positioned along the sliding direction or having even conducting sheets of other shapes are within the scope of technology of the invention when incorporated with the design of the battery conducting sheet in terms of shape and position, such that the second conducting sheet of the second battery contacts the battery conducting sheet before the first conducting sheet of the first battery is departed from battery conducting sheet and the battery can be replaced in a power-on condition.

Besides, the invention is applicable to any electronic device having a circuit board and using a battery. Moreover, the battery replacing method according to the invention is not limited to replacing a battery by a sliding way. Any battery replacing method is in compliance with the spirit of the invention as long as the second conducting sheet of second battery can be electrically connected to the battery conducting sheet to provide the circuit board with necessary power before the first conducting sheet of the first battery is electrically disconnected from the battery conducting sheet.

The mobile phone disclosed in above-mentioned two embodiments of the invention has the following advantages:

1. When replacing the battery, the mobile phone is still connected. There is no need to turn off the system of the mobile phone in order to replace the battery, saving the repeats in switching on/off the electronic device.

2. When the mobile phone is used at a hand free mode and the battery is flat, the conversation can continue in the process of replacing the battery.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device capable of replacing a first battery with a second battery in a power-on condition, wherein the first battery and the second battery respectively have a first conducting sheet and a second conducting sheet, the electronic device comprising:
a circuit board; and
a battery tray used for placing the first battery, wherein the battery tray comprises a battery conducting sheet used for contacting the first conducting sheet and supplying power to the circuit board;
wherein, when the second battery is used to replace the first battery, the second conducting sheet and the first conducting sheet contact the battery conducting sheet at the same time before the first conducting sheet is departed from the battery conducting sheet.

2. The electronic device according to claim 1, wherein the first battery and the second battery slide to be placed into or departed from the battery tray.

3. The electronic device according to claim 2, wherein the length of the battery conducting sheet is larger than the interval between the first conducting sheet and the second conducting sheet in the first battery and the second battery abutting together.

4. An electronic device capable of replacing a first battery with a second battery in a power-on condition, wherein the first battery and the second battery respectively have a first conducting sheet and a second conducting sheet, the electronic device comprising:
a circuit board; and
a battery tray used for placing the first battery, wherein the battery tray comprises:
a first battery conducting sheet used for contacting the first conducting sheet and supplying power of the first battery to the circuit board; and
a second battery conducting sheet electrically connected to the circuit board;
wherein, when a second battery is used to replace the first battery, a second conducting sheet of the second battery and the second battery conducting sheet contact and supplying power of the second battery to the circuit board before the first conducting sheet is departed from the first battery conducting sheet.

5. The electronic device according to claim 4, wherein the first battery and the second battery slide to be placed into or departed from the battery tray.

6. The electronic device according to claim 5, wherein the first battery conducting sheet and the second battery conducting sheet are positioned in the same straight line along a sliding direction of the first battery.

7. The electronic device according to claim 6, wherein the distance between the two remotest ends of the first battery conducting sheet and the second battery conducting sheet is larger than the interval between the first conducting sheet and the second conducting sheet in the first battery and the second battery abutting together.

8. A method capable of replacing a battery in a power-on condition, for replacing a first battery of an electronic device by a second battery, the electronic device comprising a battery tray used for placing the first battery or the second battery, the battery tray comprising a battery conducting sheet used for contacting a first conducting sheet of the first battery or a second conducting sheet of the second battery, the method comprising:
placing the second battery into the battery tray, such that the second conducting sheet contacts the battery conducting sheet before the first conducting sheet is departed from the battery conducting sheet; and
departing the first battery from the battery tray and placing the second battery into the battery tray completely.

9. The method according to claim 8, wherein prior to the step of placing the second battery into the battery tray, the method further comprises moving the first battery from the battery tray when the first conducting sheet remains contacting the battery conducting sheet.

10. The method according to claim 9, wherein the step of placing the second battery into the battery tray further comprises using the second battery to push against the first battery and moving the first battery and the second battery together before the first conducting sheet is departed from the battery conducting sheet.

11. The method according to claim 8, wherein prior to the step of placing the second battery into the battery tray further comprises using the second battery to press and push the first battery away from the battery tray.

12. The method according to claim 11, wherein the step of departing the first battery from the battery tray further comprises using the second battery to push against the first battery until the first battery is completely departed from the battery tray.

13. A method capable of replacing battery in a power-on condition, for replacing a first battery of an electronic device by a second battery, the electronic device comprising a battery tray used for placing the first battery or the second battery, the battery tray comprising a first battery conducting sheet and a second battery conducting sheet used for contacting a first conducting sheet of the first battery or a second conducting sheet of the second battery, the method comprising:
placing the second battery into the battery tray, such that the second conducting sheet contacts the second battery conducting sheet before the first conducting sheet is departed from the first battery conducting sheet; and
departing the first battery from the battery tray and placing the second battery into the battery tray completely.

14. The method according to claim 13, wherein prior to the step of placing the second battery into the battery tray, the method further comprises moving the first battery from the battery tray when the first conducting sheet remains contacting the first battery conducting sheet.

15. The method according to claim 14, wherein the first battery is moved from the battery tray until the second battery conducting sheet is exposed.

16. The method according to claim 14, wherein the step of placing the second battery into the battery tray further comprises using the second battery to push against the first battery and moving the first battery and the second battery together before the first conducting sheet is departed from the first battery conducting sheet.

17. The method according to claim 13, wherein the step of placing the second battery into the battery tray further comprises using the second battery to press and push the first battery away from the battery tray until the first conducting sheet and the second conducting sheet respectively contact the first battery conducting sheet and the second battery conducting sheet.

18. The method according to claim 17, wherein the step of departing the first battery from the battery tray further comprises using the second battery to push against the first battery until the first battery is completely departed from the battery tray.

19. The method according to claim 13, wherein prior to the step of departing the first battery from the battery tray, the method further comprises pushing against the second battery such that the second conducting sheet contacts the first battery conducting sheet and the second battery conducting sheet at the same time.

20. The method according to claim 13, wherein the step of departing the first battery from the battery tray further comprises pushing the second battery such that the second conducting sheet contacts the first battery conducting sheet.
